(19) United States
(12) Patent Application Publication
(10) Pub. No.: US 2024/0207858 A1
(43) Pub. Date: Jun. 27, 2024

(54) WARNING SYSTEM FOR A DECAPPING/CAPPING SYSTEM

(71) Applicant: QUEST DIAGNOSTICS INVESTMENTS LLC., Secaucus, NJ (US)

(72) Inventor: David A. HILL, Worcester, MA (US)

(21) Appl. No.: 18/288,540

(22) PCT Filed: Apr. 26, 2022
(86) PCT No.: PCT/US2022/071911

§ 371 Date: Oct. 26, 2023

Related U.S. Application Data
(60) Provisional application No. 63/180,582, filed on Apr. 27, 2021.

(51) Int. Cl. B01L 9/06; G01N 35/04

(52) U.S. Cl. CPC B01L 9/06; G01N 35/04; G01N 2035/0406; G01N 2035/0494

(57) ABSTRACT

Provided is a sample tube handling system that includes: one or more carriers configured to carry a plurality of open sample tubes containing test sample material; a deck surface including a designated location for each of the one or more carriers; and a warning system that produces a warning signal when at least one of the one or more carriers is not in its designated location.

### BACKGROUND

The present disclosure generally relates to automated sample tube decapping systems that automatically remove closures from sample tubes to get them ready for subsequent diagnostic procedure on the samples.

Some diagnostic procedures on biologic samples can be conducted by instruments that can process the samples in sample tubes without removing the closures, i.e. the caps. However, some types of instruments and/or analytical procedures require the closures on the sample tubes to be removed before the samples contained therein can be processed, then replace the closures after the procedure is complete. In applications where a large number of sample tubes need to be processed, automated sample tube decapper/capper systems are used to decap and recap the tube closures.

In such automated sample tube decapper/capper systems, the sample tubes are handled in batches with each batch comprising a plurality of sample tubes. For automated handling purposes, each batch of sample tubes are set in a carrier, i.e. a tray, that holds the sample tubes.

Sample tubes are placed in a carrier (i.e., a tray) that is configured with an array of receptacles or bins for holding the sample tubes for handling. To prepare the sample tubes for a sample processing step, a first carrier holding a batch of capped sample tubes containing samples are placed into the sample tube decapper/capper system. The placement of the first carrier into the decapper/capper system can be done manually by a person or automatically by an appropriate automated conveyor system. The first carrier is placed into the decapper/capper system at a designated location in a designated orientation so that the automated decapping/capping mechanism can properly register the position of the sample tubes in the first carrier.

The decapper/capper system then removes the closures from the sample tubes in the first carrier. After the closures are removed, the decapper/capper system transfers the open sample tubes from the first carrier to a second carrier which is configured to carry the open sample tubes to the sample processing station. In these automated sample tube decapper/capper systems, once the sample tubes are decapped, the open sample tubes are vulnerable to spills during the subsequent handling steps such as tranferring them to the second carrier. Therefore, an improved automated decapper/capper system that can minimize the risk of spills is desired.

### SUMMARY OF THE INVENTION

In decapper/capper systems currently in use, the placement of the second carrier at the designated location within the decapper/capper system is done manually by an operator, a person. As such, as disclosed herein, this transfer step is vulnerable to human error which could result in a positional error and/or a timing error for the placement of the second carrier. A positional error occurs when the physical placement of the second carrier at the designated location is improper so that the second carrier is not accurately registered at the designated location. A timing error occurs when the second carrier is not placed at the designated location at a proper time window to receive the open sample tubes.

If the second carrier is improperly positioned, the open sample tubes being set down at the designated location for the second carrier will not settle into the tube receptacles in the second carrier and the sample tubes will spill their contents. If the second carrier is missing altogether at the designated location, the open tubes will be set down on the deck of the decapper/capper system and they will tip over and spill their contents. These events are not desired because they result in loss of samples and failure to perform the intended sample processing. Spills are also not desired because they contaminate the decapper/capper system and also can create bio-hazard issues depending on the particular samples involved.

Therefore, in one aspect, this invention relates to an improvement to the decapper/capper system that can minimize or eliminate such spill events.

Provided herein is an improved automated decapper/capper system that reduce or prevent sample spills during process steps that involve transferring open sample tubes from a first carrier to a second carrier. The improvements to the automated decapper/capper system ensure that the second carrier is in proper place at a designated location on the deck of the decapper/capper system so that the open sample tubes can be properly transferred from the first carrier to the second carrier. The “deck” of the decapper/capper refers to the working surface of the decapper/capper system where the first carrier and the second carrier are positioned during the decapping/capping and sample tube transfer procedures.

### BRIEF DESCRIPTION OF THE DRAWINGS

FIG. 1 is a photograph of an example of a decapper/capper system that is fitted with a warning system according to an embodiment of the present disclosure.

FIG. 2A is a close up view of a sensor unit in the decapper/capper system shown in FIG. 1 in a scenario in which the second carrier for the open sample tubes is not in its designated location.

FIG. 2B is a close up view of the sensor unit shown in FIG. 2B in a scenario in which the second carrier for the open sample tubes is in the designated location.

FIGS. 3A-3D are schematic illustrations showing some example scenarios in a decapper/capper system according to another embodiment.

FIG. 4 is an illustration of an example of the sensor unit circuit that can be implemented in the decapper/capper system of the present disclosure.

The features shown in the above referenced drawings are illustrated schematically and are not intended to be drawn to scale nor are they intended to be shown in precise positional relationship.

### DETAILED DESCRIPTION

In the following detailed description of the preferred embodiments, reference is made to the accompanying drawings which form a part hereof, and in which are shown by way of illustration of specific embodiments in which the invention may be practiced. It is to be understood that other embodiments may be utilized and structural changes may be made without departing from the scope of the present invention.

Provided herein is an improved configuration for a decapper/capper system that warns the operator when a second carrier for receiving the open sample tubes is either missing at the designated location or not properly positioned in its designated location so that the operator can take appropriate action. Prompted by the warning, the operator can then place a second carrier if it is missing all together, adjust the position of the second carrier in the designated location so that the second carrier is positioned correctly, or pause or stop the decapper/capper system operation to prevent spilling of any open sample tubes.

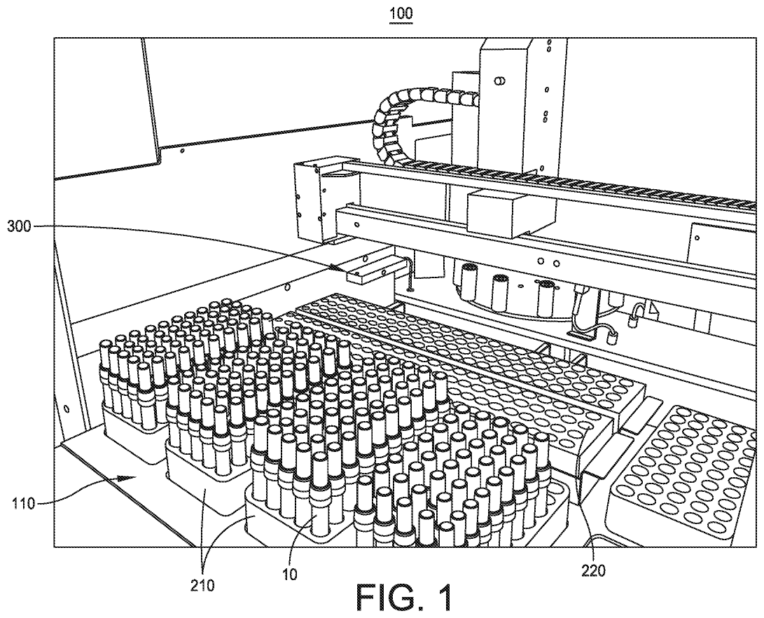

Referring to FIG. 1, according to some embodiments of the present disclosure, the improved decapper/capper system 100 comprises a deck 110 surface on which one or more first carriers 210 and one or more second carriers 220 are placed. Each of the first carriers 210 and the second carriers 220 comprises an array of a plurality of receptacles, for receiving and holding the sample tubes 10. The exact number of the first carriers and the second carriers is arbitrary because the particular number of first carriers and second carriers involved will depend on the particular configuration of each carrier with respect to the number of sample tubes each carrier can hold. There can be equal number of first carriers and second carriers to handle a given number of sample tubes if each of the first carriers and the second carriers is configured to hold a same number of sample tubes. On the other hand, if each of the first carriers are configured to hold smaller number of sample tubes than each of the second carriers, more first carriers would be required than second carriers, and vice versa. In the illustrated example shown in FIG. 1, there are four first carriers 210 and one second carrier 220.

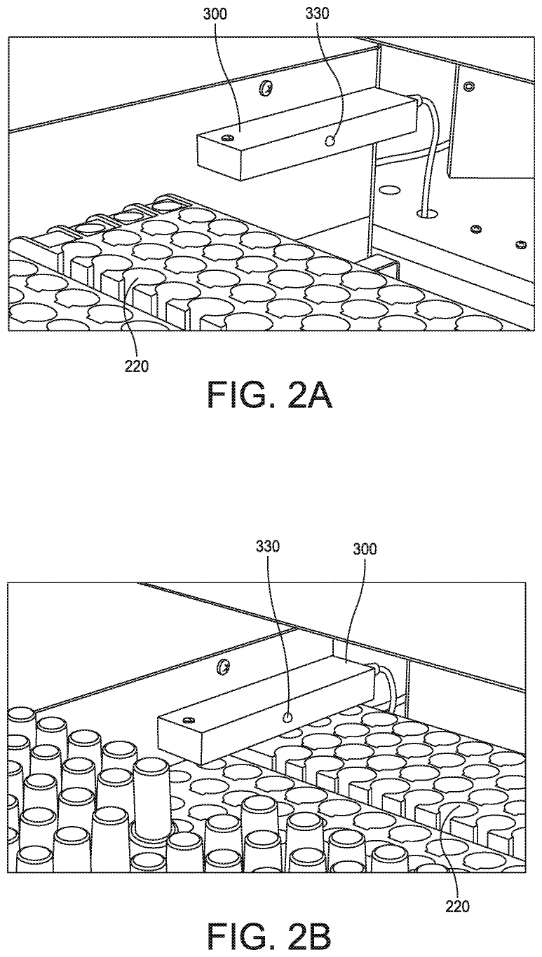

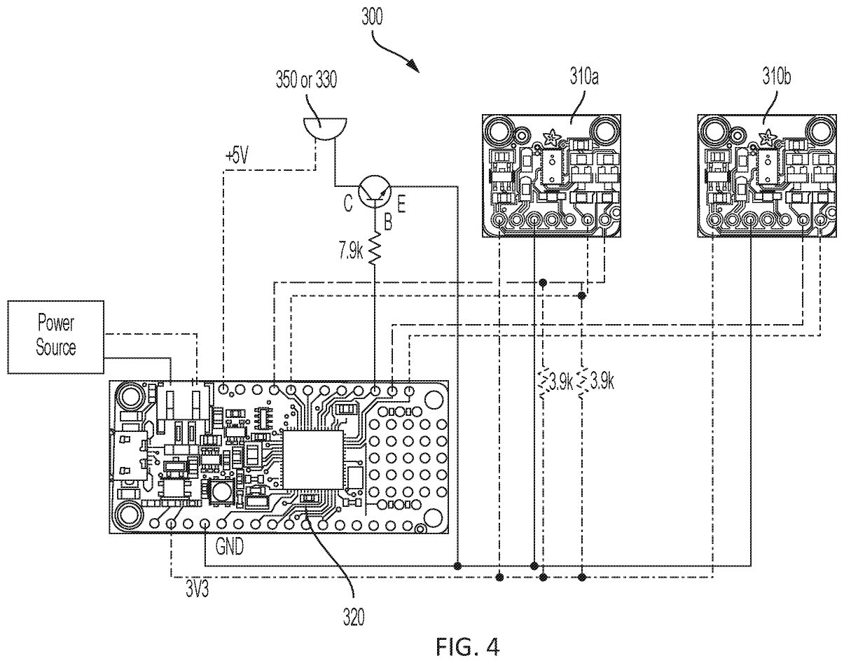

The decapper/capper system 100 can be configured with a warning system that includes a sensor unit 300 that is positioned in the proximity of the deck 110 to sense the presence of the one or more second carriers 220, and a warning signal generator (not shown). The sensor unit 300 can have one or more sensors that can detect the presence of the second carrier 220 in the designated location. There are many types of proximity sensors that can be used for this purpose that would be well known to those in the art relevant to the decapper/capper system. In the illustrated example, one second carrier 220 is expected. Thus, when the sensor unit 300 detects that the second carrier 220 is not present in its designated position, the warning system is configured to provide a desired warning signal. Such warning signal can be an audible signal, a visual signal, or a combination of both. An audible signal can be effected by an appropriate buzzer or the like. A visual signal can be effected by a light unit 330 (see FIGS. 2A-2B and FIG. 4). For example, in some embodiments, the visual signal can be turning the light unit 330 on when the sensor unit 300 detects a second carrier 220 in the designated location. In some embodiments, the light unit can be emitting red light as a default and the visual signal can be changing the color from red to green when the sensor unit 300 detects a second carrier 220 in the designated location.

In some embodiments of the decapper/capper system 100, the sensor unit 300 can be positioned above the designated location for the second carrier 220 with its one or more sensors pointing downward toward where the second carrier 220 should be if properly placed in the designated location. With such configuration, the sensor unit 300 can detect whether or not the second carrier 220 is in proper place. FIG. 2A is a close up view of an example of such sensor unit 300 employed in the illustrated example of the decapper/capper system 100.

In the scenario illustrated in FIG. 2A, the second carrier 220 is not in the designated location under the sensor unit 300. In contrast, FIG. 2B shows a scenario in which the second carrier 220 is placed in the designated location under the sensor unit 300.

In some embodiments, the sensor unit 300 can comprise one or more proximity sensors aimed toward where the second carrier 220 should be to detect whether or not the second carrier 220 is in the designated location.

In some embodiments, the sensor unit 300 positioned above the deck 110 as shown in FIG. 2A can comprise one or more distance sensors that measure distance to an object in front of them and are oriented downward toward the designated location for the second carrier 220. Thus, by measuring the distance to a surface in the field of the one or more distance sensors and comparing it to the known height of the second carrier 220 from the deck 110 surface, the warning system can detect whether or not the second carrier 220 is placed in the designated location. If the warning system does not detect the second carrier 220, the warning system can provide an appropriate warning signal, such as those described above, for the operator.

An example of the sensor unit 300 circuit is shown in FIG. 4. In this example, the sensor unit 300 comprises two time-of-flight distance sensors (AdaFruit VL6180X) 310a, 310b, and a micro-controller unit (MCU) 320 that is programmed with the necessary logic to generate the warning signal based on the distance measurements provided by the distance sensors 310a, 310b. The distance sensors 310a, 310b are configured to measure the distance between the sensors and the surface of an object that is in its line of sight. Therefore, when such distance sensors are positioned above the designated location for the second carrier 220 on the deck 110, the distance sensors will measure different distance depending on whether the second carrier 220 is in the designated location or not. If the second carrier is not in the designated location, the distance sensors will measure the distance to the deck 110 surface. If the second carrier 220 is in the designated location, the distance sensors will measure the distance to the top surface of the second carrier 220 which would be shorter than the distance to the deck 110 surface. Since the height of the second carrier 220 is a known dimension, the expected distance between the distance sensors and the top surface of the second carrier 220 can be determined in advance and programmed into the MCU's logic. The MCU 320 can be programmed to compare the measured distance provided by the distance sensors 310a, 310b to the predetermined distance to determine whether or not the second carrier 220 is properly in the designated location. The example sensor unit 300 of the warning system utilizes a buzzer 350 to provide an audible warning signal when the distance information from the distance sensors 310a indicate that the second carrier 220 is not in its designated location.

The sensor unit such as the sensor unit 300 example having two distance sensors 310a, 310b can be useful in a decapper/capper system that uses two second carriers 220a, 220b (220b is not shown) positioned side-by-side in their respective designated locations. In such scenario, the sensor unit 300 can be positioned above the two designated locations for the two second carriers 220a, 220b so that one distance sensor 310a is aligned over the second carrier 220a and the other distance sensor 310b is aligned over the second carrier 220b. Then, the MCU 320 can be programmed with appropriate logic that uses the distance information from the two distance sensors 310a, 310b, one for each of the second carriers to alert appropriate warning signals.

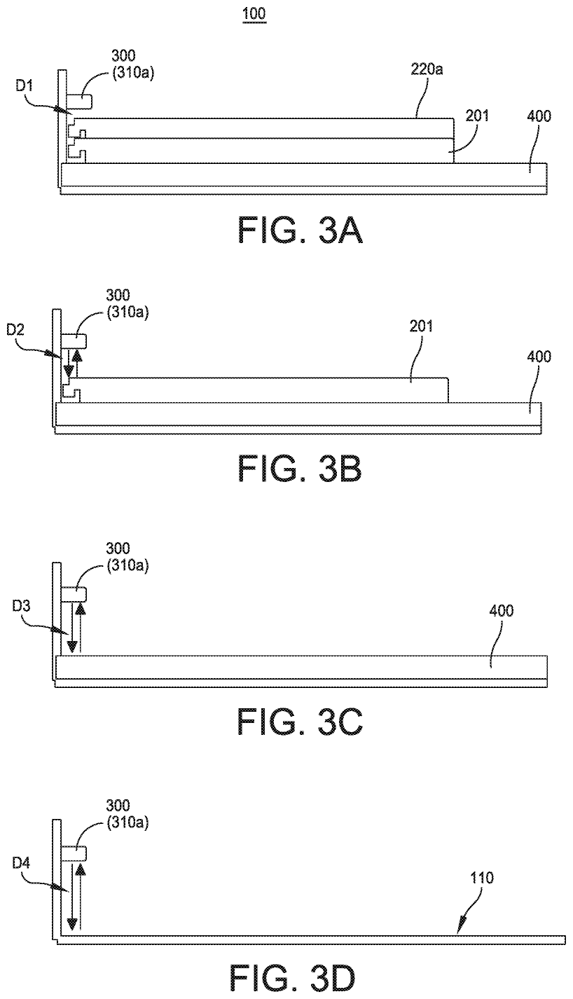

Referring to FIGS. 3A-3D, some example scenarios in the decapper/capper system 100 according to another embodiment are illustrated. In the decapper/capper system 100, the second carrier 220a for receiving the open sample tubes is required to be stacked on top of a base tray 201. The stack of the base tray 201 and the second carrier 220a can be placed on a sliding drawer 400 that transports the stacked base tray 201 and the second carrier 220a onto the deck 110. As mentioned previously, the sensor unit 300 can comprise two distance sensors 310a, 310b. The first distance sensor 310a can be aligned above the portion of the deck 110 where the presence of the second carrier 220a, the associated base tray 201 and the sliding drawer 400 can be detected.

In some embodiments, decapper/capper system 100 can include another second carrier 220b (not shown) and the second distance sensor 310b can be aligned above a different portion of the deck 110 where the presence of the other second carrier 220b can be detected.

In the scenario depicted in FIG. 3A, if the distance sensor 310a detects the expected short distance D1 when the full stack of the second carrier 220, the base tray 201, and the sliding drawer 400 are present, the MCU 320 of the warning system is configured to then drive the buzzer 350 to generate a first type of audible signal, which can be one audible beep, indicating that the second carrier 220a is in its proper designated location.

In the scenario depicted in FIG. 3B, the second carrier 220a is missing and the distance between the distance sensor 310a and the top of the base tray 201 is D2. The distance sensor 310 would detect distance D2 which is greater than D1. The MCU 320 of the warning system is configured to then drive the buzzer 350 to generate a second type of audible signal, which can be one audible beep every second, indicating that the second carrier 220a is missing until the situation is corrected.

In the scenario depicted in FIG. 3C, both the second carrier 220a and the base tray 201 are missing and the distance between the distance sensor 310a and the top of the drawer 400 is D3. The distance sensor 310a would detect distance D3 which is greater than D2. The MCU 320 of the warning system is configured to then drive the buzzer 350 to generate a third type of audible signal, which can be two audible beeps every second, indicating that both the second carrier 220a and the base tray 201 are missing until the situation is corrected.

In the scenario depicted in FIG. 3D, if the distance sensor 310a detects distance D4, the distance to the deck 110, which is greater than D3, no warning signal is generated indicating that the drawer 400 is open.

The warning signal scheme illustrated in connection with FIGS. 3A-3D are examples only and different warning signal scheme can be implemented as desired.

According to some embodiments of the present disclosure, provided is a sample tube handling system 100 that can comprise one or more carriers 220a, 220b configured to carry a plurality of sample tubes; a deck 110 surface including a designated location for each of the one or more carriers 220a, 220b; and a warning system that produces a warning signal when at least one of the one or more carriers is not in its designated location.

In some embodiments, the warning system comprises a sensor unit 300 that is positioned in the sample tube handling system 100 to detect whether each of the one or more carriers 220a, 220b is in its designated location and produces the warning signal when at least one of the one or more carriers is not in its designated location.

In some embodiments, the warning system comprises at least one buzzer 350 and the warning signal is an audible signal. In some embodiments, the warning system can comprise at least one light unit 330 and the warning signal is a visual signal provided by the light unit. In some embodiments of the sample tube handling system 100, the warning system can include at least one buzzer 350 and at least one light unit 330 so that the warning system can utilize one or both of an audible signal and a visual signal. In some embodiments, the warning system does not produce any warning signal when the one or more carriers are in their designated locations.

In some embodiments, the sensor unit 300 comprises a distance sensor for each of the designated location for each of the one or more carriers 220a, 220b, that measures distance between the distance sensor to a surface that is in the distance sensor's line of sight, wherein the sample tube handling system uses the measured distance to detect whether each of the one or more carriers is in its designated location.

Also provided is an embodiment of a sample tube handling system 100 comprising a carrier 220 configured to carry a plurality of sample tubes; a deck 110 surface including a designated location for the carrier 220; and a warning system that produces a warning signal when the carrier is not in the designated location.

In this embodiment, the warning system comprises a sensor unit 300 that is positioned in the sample tube handling system 100 to detect whether the carrier 220 is in its designated location and produces the warning signal when the carrier is not in its designated location. In some embodiments, the warning system can comprise at least one buzzer 350 and the warning signal is an audible signal. In some embodiments, the warning system can comprise at least one light unit 330 and the warning signal is a visual signal provided by the light unit. In some embodiments, the warning system can comprise at least one buzzer 350 and at least one light unit 330 so that the system can implement one or both of an audible signal and a visual signal. In this embodiment of the sample tube handling system 100, the warning system does not produce any warning signal when the carrier is in its designated location. In some embodiments, the sensor unit 300 can comprise a distance sensor for the designated location, wherein the distance sensor measures distance between the distance sensor to a surface that is in the distance sensor's line of sight, wherein the sample tube handling system uses the measured distance to detect whether the carrier is in its designated location.

In the illustrated example shown in FIG. 1, the decapper/capper system 100 is a Flex 900 system manufactured by Sarstedt AG & Co. KG, Germany. However the scope of the invention described herein is not limited to any particular decapper/capper system and can be applied to any other decapper/capper system that utilizes a sequence where the sample tubes are decapped while in a first carrier, then the open sample tubes are transferred to a second carrier for the subsequent processing.

The various embodiments disclosed herein represent examples that fall within the scope of the invention but does not necessarily define the full scope of the invention. The full scope of the invention is defined by the claims provided herein.

What is claimed is:

1. A sample tube handling system comprising:
one or more carriers configured to carry a plurality of sample tubes;
a deck surface including a designated location for each of the one or more carriers; and
a warning system that produces a warning signal when at least one of the one or more carriers is not in its designated location.

2. The sample tube handling system of claim 1, wherein the warning system comprises a sensor unit that is positioned in the sample tube handling system to detect whether each of the one or more carriers is in its designated location and produces the warning signal when at least one of the one or more carriers is not in its designated location.

3. The sample tube handling system of claim 2, wherein the warning system comprises at least one buzzer and the warning signal is an audible signal.

4. The sample tube handling system of claim 2, wherein the warning system comprises at least one light unit and the warning signal is a visual signal provided by the light unit.

5. The sample tube handling system of claim 2, wherein the warning system comprises at least one buzzer and at least one light unit and the warning signal can include an audible signal, a visual signal, or both audible and visual signals.

6. The sample tube handling system of claim 1, wherein the warning system does not produce any warning signal when the one or more carriers are in their designated locations.

7. The sample tube handling system of claim 2, wherein the sensor unit comprises a distance sensor for each of the designated location for each of the one or more carriers, that measures distance between the distance sensor to a surface that is in the distance sensor's line of sight, wherein the sample tube handling system uses the measured distance to detect whether each of the one or more carriers is in its designated location.

8. A sample tube handling system comprising:
a carrier configured to carry a plurality of sample tubes;
a deck surface including a designated location for the carrier; and
a warning system that produces a warning signal when the carrier is not in the designated location.

9. The sample tube handling system of claim 8, wherein the warning system comprises a sensor unit that is positioned in the sample tube handling system to detect whether the carrier is in its designated location and produces the warning signal when the carrier is not in its designated location.

10. The sample tube handling system of claim 9, wherein the warning system comprises a buzzer and the warning signal is an audible signal.

11. The sample tube handling system of claim 9, wherein the warning system comprises a light unit and the warning signal is a visual signal provided by the light unit.

12. The sample tube handling system of claim 9, wherein the warning system comprises at least one buzzer and at least one light unit and the warning signal can include an audible signal, a visual signal, or both audible and visual signals.

13. The sample tube handling system of claim 8, wherein the warning system does not produce any warning signal when the carrier is in its designated location.

14. The sample tube handling system of claim 9, wherein the sensor unit comprises a distance sensor for the designated location, wherein the distance sensor measures distance between the distance sensor to a surface that is in the distance sensor's line of sight, wherein the sample tube handling system uses the measured distance to detect whether the carrier is in its designated location.
